(19) United States
(12) Patent Application Publication
(10) Pub. No.: US 2016/0029858 A1
(43) Pub. Date: Feb. 4, 2016

(54) ADULT AND CHILD VEHICLE PORTER POTTY SEATING

(71) Applicant: Danisha Lashune Taylor, Lancaster, CA (US)

(72) Inventor: Danisha Lashune Taylor, Lancaster, CA (US)

(21) Appl. No.: 14/882,362

(22) Filed: Oct. 13, 2015

(51) Int. Cl. A47K 11/04; B60N 3/08

(52) U.S. Cl. CPC A47K 11/04; B60N 3/08

(57) ABSTRACT

The embodiments herein provide a portable vehicular adult and child potty seat with ease-of-excretion enhancement during a journey. The adult and child potty seats are removable in nature with detachable components comprising the automatic lid, the cushioned commode seater, the automatic flush, the liquid storage tank, the drain module and the disposable collecting bag. Thus each component is cleansed and reassembled to enhance longevity of the components. Also, during a failure or breakage or wearing of specific component, only the failed components are replaced with the new one resulting easy and cost effective maintenance. Further, the present invention provides an assembly of the potty seat that is easily installed within the vehicle seat to enhance an ease-of-use feature during an excretion emergency.

### BACKGROUND

1. Technical Field of Invention

The embodiments herein generally relate to a personal utility apparatus and particularly relates to a portable toilet with fixation arrangement for being used in an automobile. The embodiments herein more particularly relate to an adult and child potty seating fixed into a seating arrangement of the automobile to provide a readily available solution for excretion during a journey and a place with unavailability of hygienic toilet.

2. Description of Related Art

The portable toilets, often referred to as porta-potties, Port-a-Johns (American English), or Portaloos™ (UK), are simple portable enclosures containing a chemical toilet (a toilet bowl filled with disinfectant instead of water) which are typically used as a temporary toilet for construction sites or large gatherings because of their durability and convenience. Most portable toilets have black open-front U-shaped toilet seats with a cover. They are often constructed out of lightweight molded plastic.

One of the prior art discloses a portable and disposable sanitary toilet seat cover comprising an annulus for placement on the toilet seat, the annulus having depending from its inner and outer boundaries inner and outer skirts. A drawstring is reaved into the annulus adjacent the relatively outer boundary thereof and also passes through a perforation at the rear of a cover provided with a glove in stoved condition. When the toilet is used, the actuation of the drawstring collapses the annulus and its skirts and releases the stowed glove. Following full collapse of the cover, a hand is inserted into the glove to grasp the crumpled cover and the glove is then inverted to encase the used toilet seat cover for hygienic disposal.

Another prior art discloses a portable toilet seat comprising a horseshoe shaped base having an inner surface and an outer surface, a top surface and a bottom surface, a front region and an open centre. A plurality of telescoping legs extend downward from the bottom surface and retract into appropriately sized recesses which are also disposed about the bottom surface of the base. A lip extends around the perimeter of the inner surface for engaging a deformable waste receptacle such as a bag. The portable toilet bowl is used by retracting the telescoping legs and placing the base on top of a standard toilet bowl to prevent unsanitary bodily contact therewith. When a standard toilet bowl is unavailable, the plurality of legs may be extended to support the base above a surface such as the ground, thus allowing a user to deposit human waste through the centre upon said surface, or into the deformable waste receptacle is so desired.

Yet another prior art discloses a portable toilet seat usable in a wilderness environment where there is no plumbing system available for operatively connecting a conventional toilet. The toilet seat includes a seat member having a clamp means at its rear edge for rigidly attaching the seat member to the trunk of a tree in a wilderness setting. A foldable leg structure is swingably attached to the front edge area of the seat member for supporting the front portion of the seat member. The leg structure can be folded against the seat member for storage or transport purposes.

However, the conventional portable toilet seats have complex assemblies and need to be carried separately while travelling. Also, the conventional portable toilet seats have limitation in their carriage during a journey.

In the view of foregoing, there is a need for a portable toilet seat with a simple assembly that can be easily installed in a vehicle. Also, there is a need for a portable toilet seat with independent working capability during an emergency to relieve the user from stopping or detouring a vehicle mandatorily towards a restaurant or a permanent lavatory.

The above mentioned shortcomings, disadvantages and problems are addressed herein, as detailed below.

### SUMMARY OF THE INVENTION

The primary object of the embodiments herein is to provide a portable potty seat for adults and child ported in a vehicle for an in journey utility.

Another object of the embodiments herein is to provide a modular potty seat assembly to be housed under a vehicle seat and provides a flexibility of quickly flexing the seat to use the potty seat for excretion.

Yet another object of the embodiments herein is to provide a portable potty seat assembly with independent usage capability i.e. storage tank and water chamber that results in avoiding a detouring or stopping of the vehicle over a restaurant or a lavatory.

Yet another object of the embodiments herein is to provide a portable potty seat assembly having a water mixture compartment for an immediate clean-up of the commode and removal of the excreta odour.

According to one embodiment herein, a portable vehicular adult potty seat with ease-of-excretion enhancement during a journey is provided. The potty seat comprises a cushioned commode seater. The cushioned commode seater is present below an automatic lid The cushioned commode seater appears on sliding up of an automatic lid and the automatic lid is fabricated in a form of a vehicle seat. A push button is present on the vehicle seat, and the automatic lid is connected with the push button through an actuator means. An automatic flush is connected with the push button and comprises a pump connected with the cushioned commode seater through a first tubing. A liquid storage tank is connected with the cushioned commode seater through the pump and a drain module is connected with the liquid storage tank through a second tubing.

The liquid storage tank further comprises a waste compartment and a chemical compartment. The waste compartment is connected with the pump and the chemical compartment lies in a plane of the waste compartment. The chemical compartment has a mixture of water and a chemical for removing an odour of excreta. The water and chemical mixture also cleans the commode seat. The chemical compartment has a capacity of atleast 200 litres. The chemical is present in an amount of atleast 100 ml. The chemical is a bactericide and a perfuming agent. A third tubing connects the chemical compartment to the automatic flush.

The pump creates a vacuum suction on pushing the push button by the user after excretion and transfers the sucked excreta to the waste compartment. The chemical and water mixture is pumped to the automatic flush from the chemical compartment through the third tubing to remove and clean an odour of excreta.

The first, second and third tubing are made up of a polymerized plastic, primarily a Poly Vinyl Chloride (PVC) material.

The automatic lid is held to the cushioned commode seater and the vehicle seat through a lift and locking mechanism.

The drain module further comprises a drain valve, an extendable hose, and a removable container. The drain valve is connected with the waste compartment while the extendable hose is connected with the drain valve. The extendable hose has a collapsible rivet structure to increase or decrease a length. The removable container is in turn connected with the drain valve through the extendable hose.

The cushioned commode seater and the automatic lid is made up of a fiberglass material.

The liquid storage tank comprising a water mixture compartment has a capacity of at-least 200 litre. The liquid storage tank comprising a water mixture compartment has a chemical and water mixture, wherein the chemical is present in a quantity of atleast 100 ml.

According to another embodiment herein, a portable vehicular child potty seat with ease-of-excretion enhancement during a journey is provided. The potty seat comprises a push button, wherein the push button is attached to a seat of a vehicle. An automatic lid is connected with the push button through an actuator means. The automatic lid is fabricated in the form of the vehicle seat. A cushioned commode seater is provided below the automatic lid and appears on sliding up of the automatic lid by a first pushing of the push button. A disposable collecting bag is attached in the cushioned commode seater in a manner to receive an excreta and while a second press of the push button closes the automatic lid and the cushioned commode seater is transformed again into a vehicle seat.

A disposable collecting bag is attached with the cushioned commode seater through at-least four detachable latches. The disposable collecting bag comprises a handle and forms a housing for receiving excreta. The disposable collecting bag is detached by detaching the at-least four latches and sliding out by holding the handle.

The cushioned commode seater and the automatic lid is made up of a fiberglass material. The disposable collecting bag is made up of non-porous polymerized plastic material.

The automatic lid is held to the cushioned commode seater and the vehicle seat through a lift and locking mechanism.

The embodiments herein provide a portable vehicular adult potty seat with ease-of-excretion enhancement during a journey. The potty seat comprises a push button, an automatic lid, a cushioned commode seater, an automatic flush, a liquid storage tank and a drain module. The push button is attached to a seat of the vehicle. The automatic lid is connected to the push button through an actuator means. The automatic lid is fabricated in the form of the vehicle seat. The cushioned commode seater is provided below the automatic lid. The cushioned commode seater appear on sliding up of the automatic lid. The automatic flush is connected to the push button. The automatic flush comprises a pump connected to the cushioned commode seater through a first tubing. The liquid storage tank is connected to the cushioned commode seater through the pump. The drain module is connected to the liquid storage tank trough a second tubing.

According to one embodiment herein, the liquid storage tank further comprises a waste compartment, a chemical compartment and a third tubing. The waste compartment comprises a mixture of liquid and user excreta. The waste compartment is connected to the pump. The chemical compartment lies in a plane of the waste compartment and has a mixture of an odour removing chemical and water. The third tubing connects the chemical compartment to the automatic flush. The pump creates a vacuum suction on pushing the push button by the user after excretion. The pump transfers the sucked excreta to the waste compartment. A water and chemical mixture is pumped to the automatic flush from the chemical compartment through the third tubing to remove an odour of excreta.

According to one embodiment herein, the first and second tubing are a polymerized plastic, primarily a Poly Vinyl Chloride (PVC) material.

According to one embodiment herein, the third tubing are a polymerized plastic, primarily a Poly Vinyl Chloride (PVC) material.

According to one embodiment herein, the automatic lid is held to the cushioned commode seater and the vehicle seat through a lift and locking mechanism.

According to one embodiment herein, the drain module further comprises a drain valve, an extendable hose and a removable container. The drain valve is connected to the waste compartment. The extendable hose is connected to the drain valve. The extendable hose has collapsible rivet structure to increase or decrease a length. The removable container is connected to the drain valve through the extendable hose.

According to one embodiment herein, the cushioned commode seater and the automatic lid is made up of a fiberglass material.

According to one embodiment herein, the chemical compartment is at-least 200 litre capacity with 100 ml of chemical.

The embodiments herein provide a portable vehicular child potty seat with ease-of-excretion enhancement during a journey. The potty seat comprises a push button, an automatic lid, a cushioned commode seater and a disposable collecting bag. The push button is attached to a seat of the vehicle. The automatic lid is connected to the push button through an actuator means. The automatic lid is fabricated in the form of the vehicle seat. The cushioned commode seater is provided below the automatic lid. The cushioned commode seater appear on sliding up of the automatic lid by a first pushing of the push button. The disposable collecting bag is attached in the cushioned commode seater in a manner to receive a child's excreta. A second press of the push button closes the automatic lid and the cushioned commode seater is transformed again into a vehicle seater.

According to one embodiment herein, the disposable collecting bag is attached to the cushioned commode seater through at-least four detachable latches. The disposable collecting bag comprises a holding handle. The disposable collecting bag forms an excreta receiving commode housing during an attachment with the cushioned commode seater.

According to one embodiment herein, the disposable collecting bag is detached by removing the at-least four latches and sliding out through the holding handle.

According to one embodiment herein, the cushioned commode seater and the automatic lid is made up of a fiberglass material.

According to one embodiment herein, the disposable collecting bag is made up of non-porous polymerized plastic material.

According to one embodiment herein, the automatic lid is held to the cushioned commode seater and the vehicle seat through a lift and locking mechanism.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a perspective view of the portable adult potty seat fixed to a vehicle, according to an embodiment herein.

FIG. 2A illustrates a top view of the portable child potty seat fixed to a vehicle, according to an embodiment herein.

FIG. 2B illustrates a bottom perspective view of the portable child potty seat fixed to a vehicle, according to an embodiment herein.

FIG. 2C illustrates a side view of the portable child potty seat fixed to a vehicle, according to an embodiment herein.

FIG. 3 illustrates a side view of the portable child potty seat with a slided out disposable bag, according to an embodiment herein.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a portable vehicular adult potty seat with ease-of-excretion enhancement during a journey. The potty seat comprises a push button, an automatic lid, a cushioned commode seater, an automatic flush, a liquid storage tank and a drain module. The push button is attached to a seat of the vehicle. The automatic lid is connected to the push button through an actuator means. The automatic lid is fabricated in the form of the vehicle seat. The cushioned commode seater is provided below the automatic lid. The cushioned commode seater appear on sliding up of the automatic lid. The automatic flush is connected to the push button. The automatic flush comprises a pump connected to the cushioned commode seater through a first tubing. The liquid storage tank is connected to the cushioned commode seater through the pump. The drain module is connected to the liquid storage tank through a second tubing.

According to one embodiment herein, the liquid storage tank further comprises a waste compartment, a chemical compartment and a third tubing. The waste compartment comprises a mixture of liquid and user excreta. The waste compartment is connected to the pump. The chemical compartment lies in a plane of the waste compartment and has a mixture of an odour removing chemical and water. The third tubing connects the chemical compartment to the automatic flush. The pump creates a vacuum suction on pushing the push button by the user after excretion. The pump transfers the sucked excreta to the waste compartment. A water and chemical mixture is pumped to the automatic flush from the chemical compartment through the third tubing to remove an odour of excreta.

According to one embodiment herein, the first and second tubing are a polymerized plastic, primarily a Poly Vinyl Chloride (PVC) material.

According to one embodiment herein, the third tubing are a polymerized plastic, primarily a Poly Vinyl Chloride (PVC) material.

According to one embodiment herein, the automatic lid is held to the cushioned commode seater and the vehicle seat through a lift and locking mechanism.

According to one embodiment herein, the drain module further comprises a drain valve, an extendable hose and a removable container. The drain valve is connected to the waste compartment. The extendable hose is connected to the drain valve. The extendable hose has collapsible rivet structure to increase or decrease a length. The removable container is connected to the drain valve through the extendable hose.

According to one embodiment herein, the cushioned commode seater and the automatic lid is made up of a fiberglass material.

According to one embodiment herein, the chemical compartment is at-least 200 litre capacity with 100 ml of chemical. The water and chemical mixture is bactericidal in nature. The chemical comprises a mixture of a bactericide and a perfuming agent according to one embodiment herein.

The embodiments herein provide a portable vehicular child potty seat with ease-of-excretion enhancement during a journey. The potty seat comprises a push button, an automatic lid, a cushioned commode seater and a disposable collecting bag. The push button is attached to a seat of the vehicle. The automatic lid is connected to the push button through an actuator means. The automatic lid is fabricated in the form of the vehicle seat. The cushioned commode seater is provided below the automatic lid. The cushioned commode seater appear on sliding up of the automatic lid by a first pushing of the push button. The disposable collecting bag is attached in the cushioned commode seater in a manner to receive a child's excreta. A second press of the push button closes the automatic lid and the cushioned commode seater is transformed again into a vehicle seater.

According to one embodiment herein, the disposable collecting bag is attached to the cushioned commode seater through at-least four detachable latches. The disposable collecting bag comprises a holding handle. The disposable collecting bag forms an excreta receiving commode housing during an attachment with the cushioned commode seater.

According to one embodiment herein, the disposable collecting bag is detached by removing the at-least four latches and sliding out through the holding handle.

According to one embodiment herein, the cushioned commode seater and the automatic lid is made up of a fiberglass material.

According to one embodiment herein, the disposable collecting bag is made up of non-porous polymerized plastic material.

According to one embodiment herein, the automatic lid is held to the cushioned commode seater and the vehicle seat through a lift and locking mechanism.

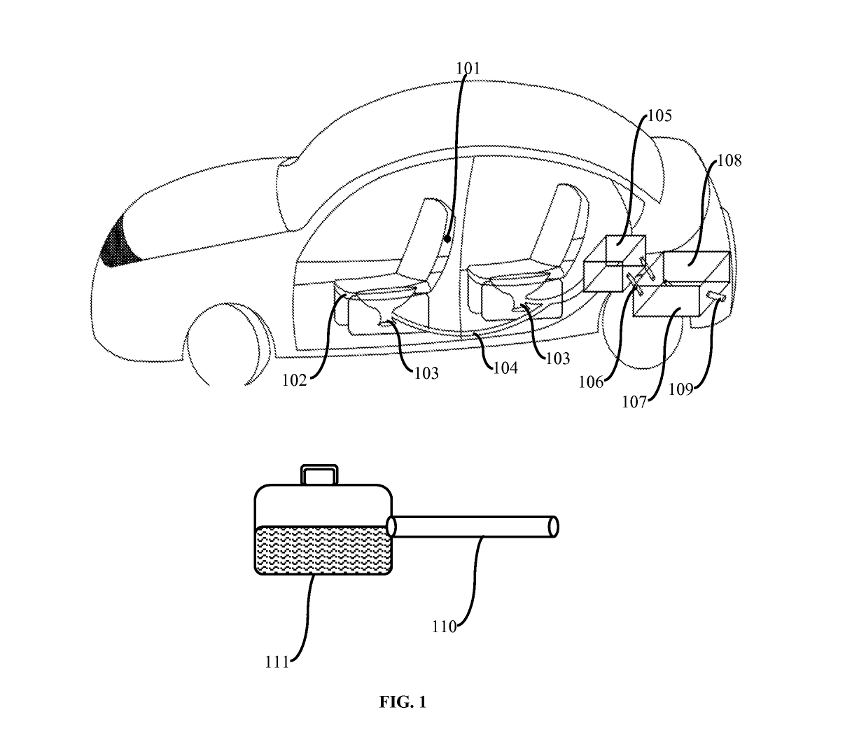

FIG. 1 illustrates a perspective view of the portable adult potty seat fixed to a vehicle, according to an embodiment herein. With respect to FIG. 1, the push button 101 is alternatively provided at the side of the vehicle seat 102 or any other suitable position in the vehicle. The automatic lid and the cushioned commode seater 103 is provided underneath the vehicle seat 102 and appears on pressing the push button 101. The opening and closing mechanism of the automatic lid is controlled through an actuator further connected to a controller circuit placed inside the vehicle seat 101 or any suitable position. The cushioned commode seater 103 is connected with the pump 105 through the first tubing 104. The first tubing 104 comprises various channels connected to each one or more cushioned commode seater 103 inside the vehicle. The channels coincide to a single point into a broader channel which carries the excreta to the waste compartment 106. The pump 105 creates a vacuum suction to suck out the excreta from each cushioned commode seater 103 after the user presses the push button 101 for the second time. The collected excreta is passed into the waste compartment 108 followed by channelling of the mixture of chemical water from the chemical compartment 107 to each cushioned commode seater 103 through the third tubing 106, the pump 105 and the first tubing 104. The collected excreta is drained out through the drain valve 109 and the second tubing into the removable container 111. The drain valve 109 is connected to the removable container 111 through the extendable hose 110. The removable container 110 is removed and the collected excreta is dumped into a waste storage trolleys or garbage containers installed on roadside or in public lavatories.

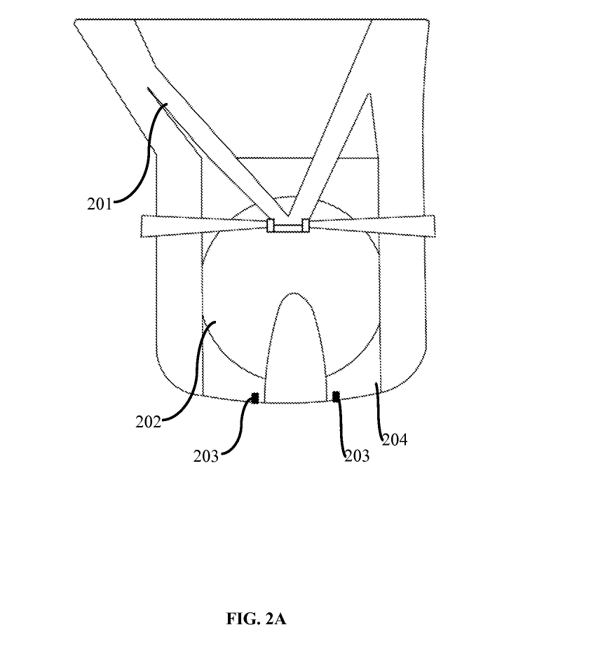

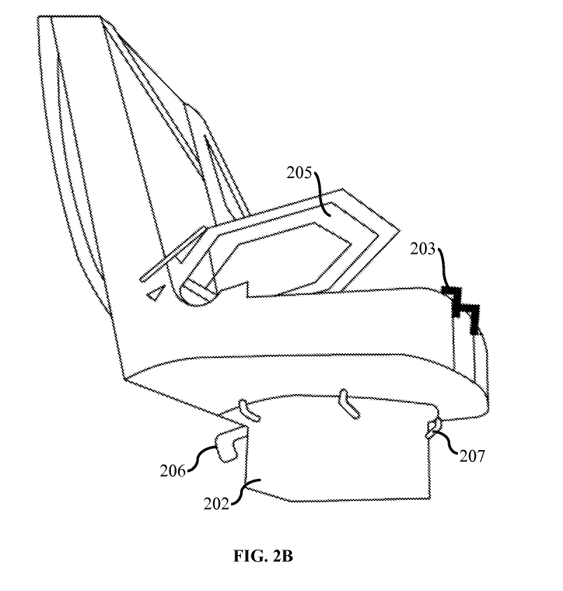

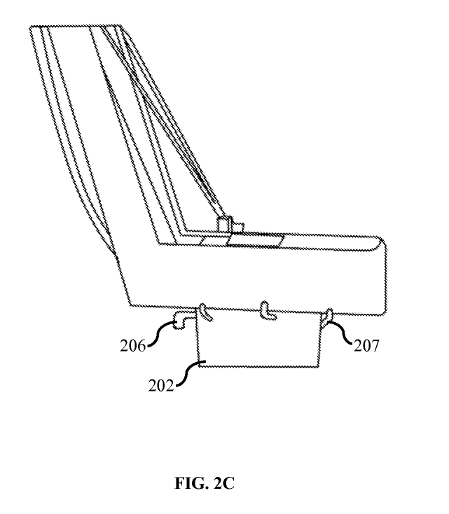

FIG. 2A-2C illustrates a top view, bottom perspective view and a side view of the portable child potty seat fixed to a vehicle, respectively, according to an embodiment herein. With respect to FIG. 2A-2C, the child potty seat is suitable placed at anyone or more vehicle seat. During an excretion, a child is held to the garments through the safety belt 201. Then, the push button placed at a suitable position in the vehicle is pressed. The pressing of the push button results in removal of the vehicle seat and sliding in or swinging up of the automatic lid 205 to allow the child to sit over the cushioned commode seater 204. The automatic lid 205 is connected to a spring mechanism and constantly has a vertical tension. The lift and lock mechanism 203 hold the automatic lid from swinging up until the push button is pressed. The pressing of the push button lifts and unlocks the lift and lock mechanism 203 which allows the automatic lid 205 to swing up. The cushioned commode seater 204 houses a disposable collecting bag 202 which forms an excreta collection chamber. The disposable collecting bag 202 is alternatively installed with an odour removal spray. The disposable collecting bag 202 is held to the cushioned commode seater 204 through the at-least four detachable latches 207.

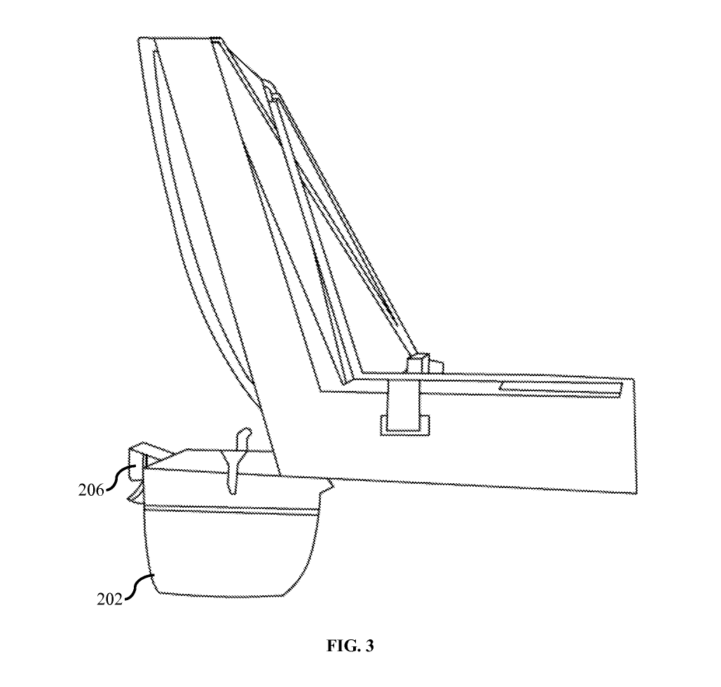

FIG. 3 illustrates a side view of the portable child potty seat with slided out disposable bag, according to an embodiment herein. With respect to FIG. 3, the disposable collecting bag 202 is placed into the cushioned commode seater in a sliding manner and is slided back for excreta disposal into a public garbage container through the holding handle 206 provided on the rear face of the disposable collecting bag 202.

According to the embodiments herein, the adult and child potty seats are removable in nature with detachable components comprising the automatic lid, the cushioned commode seater, the automatic flush, the liquid storage tank, the drain module and the disposable collecting bag. Thus each component is cleansed and reassembled to enhance longevity of the components. Also, during a failure or breakage or wearing of specific component, only the failed components are replaced with the new one resulting easy and cost effective maintenance. Further, the present invention provides an assembly of the potty seat that is easily installed within the vehicle seat to enhance an ease-of-use feature during an excretion emergency.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A portable vehicular adult potty seat with ease-of-excretion enhancement during a journey, the potty seat comprises:
a cushioned commode seater, wherein the cushioned commode seater is present below an automatic lid, wherein the cushioned commode seater appears on sliding up of the automatic lid and wherein the automatic lid is fabricated in a form of a vehicle seat;
a push button, wherein the push button is present on the vehicle seat, and wherein the automatic lid is connected with the push button through an actuator means;
an automatic flush, wherein the automatic flush is connected with the push button, wherein the automatic flush comprises a pump connected with the cushioned commode seater through a first tubing;
a liquid storage tank, wherein the liquid storage tank is connected with the cushioned commode seater through the pump; and
a drain module, wherein the drain module is connected with the liquid storage tank through a second tubing.

2. The potty seat according to claim 1, wherein the liquid storage tank further comprises:
a waste compartment, wherein the waste compartment is connected with the pump;
a chemical compartment, wherein the chemical compartment lies in a plane of the waste compartment, wherein the chemical compartment has a mixture of an odour removing chemical and water;
a third tubing, wherein the third tubing connects the chemical compartment to the automatic flush;
wherein, the pump creates a vacuum suction on pushing the push button by the user after excretion, wherein the pump transfers the sucked excreta to the waste compartment, wherein, a chemical and water mixture is pumped to the automatic flush from the chemical compartment through the third tubing to remove and clean an odour of excreta.

3. The potty seat according to claim 1, wherein the first and second tubing are a polymerized plastic, primarily a Poly Vinyl Chloride (PVC) material.

4. The potty seat according to claim 2, wherein the third tubing are a polymerized plastic, primarily a Poly Vinyl Chloride (PVC) material.

5. The potty seat according to claim 1, wherein the automatic lid is held to the cushioned commode seater and the vehicle seat through a lift and locking mechanism.

6. The potty seat according to claim 1, wherein the drain module further comprises:
a drain valve, wherein the drain valve is connected with the waste compartment;
an extendable hose, wherein the extendable hose is connected with the drain valve, wherein the extendable hose has a collapsible rivet structure to increase or decrease a length;
a removable container, wherein the removable container is connected with the drain valve through the extendable hose.

7. The potty seat according to claim 1, wherein the cushioned commode seater and the automatic lid is made up of a fiberglass material.

8. The potty seat according to claim 1, wherein the liquid storage tank comprising a chemical compartment has a capacity of at-least 200 litre.

9. The potty seat according to claim 1, wherein the liquid storage tank comprising a chemical compartment has a chemical and water mixture, wherein the chemical is present in a quantity of atleast 100 ml.

10. A portable vehicular child potty seat with ease-of-excretion enhancement during a journey, the potty seat comprises:
a push button, wherein the push button is attached to a seat of a vehicle;
an automatic lid, wherein the automatic lid is connected with the push button through an actuator means, wherein the automatic lid is fabricated in the form of the vehicle seat;
a cushioned commode seater, wherein the cushioned commode seater is provided below the automatic lid, wherein the cushioned commode seater appears on sliding up of the automatic lid by a first pushing of the push button;
a disposable collecting bag, wherein the disposable collecting bag is attached in the cushioned commode seater in a manner to receive an excreta;
wherein, a second press of the push button closes the automatic lid and the cushioned commode seater is transformed again into a vehicle seat.

11. The potty seat according to claim 10, wherein the disposable collecting bag is attached with the cushioned commode seater through at-least four detachable latches, wherein the disposable collecting bag comprises a handle, wherein the disposable collecting bag forms an excreta receiving housing.

12. The potty seat according to claim 10, wherein the disposable collecting bag is detached by detaching the at-least four latches and sliding out by holding the handle.

13. The potty seat according to claim 10, wherein the cushioned commode seater and the automatic lid is made up of a fiberglass material.

14. The potty seat according to claim 10, wherein the disposable collecting bag is made up of non-porous polymerized plastic material.

15. The potty seat according to claim 10, wherein the automatic lid is held to the cushioned commode seater and the vehicle seat through a lift and locking mechanism.
